(19) United States
(12) Patent Application Publication
(10) Pub. No.: US 2018/0338636 A1
(43) Pub. Date: Nov. 29, 2018

(54) COOKING HOB WITH STEAM GENERATOR

(71) Applicant: ELECTROLUX APPLIANCES AKTIEBOLAG, Stockholm (SE)

(72) Inventor: Carlo Andrea Ceccoli, Forli (IT)

(21) Appl. No.: 15/778,245

(22) PCT Filed: Nov. 9, 2016
(86) PCT No.: PCT/EP2016/077043

§ 371 Date: May 23, 2018

(30) Foreign Application Priority Data
Dec. 1, 2015 (EP) 15197209.8

(51) Int. Cl. A47J 27/04; F24C 15/10; F24C 15/32

(52) U.S. Cl. CPC A47J 27/04; A47J 2027/043; F24C 15/327; F24C 15/10

(57) ABSTRACT

The present invention relates to a cooking hob (10) with a steam generator. The cooking hob (10) comprises a glass ceramic panel (12) including at least one recess (36) and at least one water reservoir (14) arranged beneath said recess (36). The cooking hob (10) comprises at least one removable lid (16) for closing the recess (36). The lid (16) includes a plurality of lid holes (40) permeable for steam (32). The cooking hob (10) comprises at least one heating element (20) arranged beneath, besides and/or inside the water reservoir (14). The lid (16) is arranged or arrangeable in the recess (36) of the glass ceramic panel (12), so that the upper surfaces of the lid (16) and the glass ceramic panel (12) are at the same level and form either a smooth or a smooth and partially concave surface. The lid (16) and/or a portion of the glass ceramic panel (12) encircling said lid (16) are provided for supporting a standard steam cooking pot (30) or a bamboo steamer, so that steam (32) is directed from the water reservoir (14) through the lid holes (40) into the steam cooking pot (30) or the bamboo steamer, respectively. Further, the present invention relates to a method for controlling a steam cooking process performed by a cooking hob (10) with at least one steam generator.

The present invention relates to a cooking hob with a steam generator. Further, the present invention relates to a method for controlling a steam cooking process performed by a cooking hob with at least one steam generator.

The preparing and cooking of food stuff is increasingly performed by a steam cooking process. Usually, the steam cooking process is performed by special cooking devices. For example, a steam cooking pot is arranged above a compatible steam generator. Said steam generator may comprise an own heating element and water reservoir. Further, the steam generator is arrangeable upon a cooking hob, so that water in the water reservoir is heated up. In the latter case, the steam generator requires no own heating element. Often, the steam cooking process is performed by freestanding cooking devices.

It is an object of the present invention to provide a cooking hob with a steam generator, which allows a steam cooking process with a standard steam cooking pot by low complexity.

The object is achieved by a cooking hob with a steam generator according to claim 1.

The present invention provides a cooking hob with at least one steam generator, wherein:
the cooking hob comprises a glass ceramic panel including at least one recess,
the cooking hob comprises at least one water reservoir arranged beneath the recess,
the cooking hob comprises at least one removable lid for closing the recess,
the recess includes a plurality of lid holes permeable for steam,
the cooking hob comprises at least one heating element arranged beneath, besides and/or inside the water reservoir,
the lid is arranged or arrangeable in the recess of the glass ceramic panel, so that the upper surfaces of the lid and the glass ceramic panel are at the same level and form either a smooth or a smooth and partially concave surface, and
the lid and/or a portion of the glass ceramic panel encircling said lid are provided for supporting a standard steam cooking pot or a bamboo steamer, so that steam is directed from the water reservoir through the lid holes into the steam cooking pot or the bamboo steamer, respectively.

The cooking hob according to the present invention comprises an integrated steam generator. The cooking hob with steam generator is compatible with every kind of standard steam cooking pot and bamboo steamers. The cooking hob with steam generator injects real steam directly into the steam cooking pot or bamboo steamer, respectively. The design of the cooking hob with steam generator is similar as a conventional cooking hob without steam generator. The steam generator is unremarkably integrated within the cooking hob.

For example, the lid is made of ceramic glass, wherein preferably said lid is made of the same material as the glass ceramic panel. The surfaces of the lid and the glass ceramic panel may have the same design, which is aesthetically advantageous.

In particular, the size of the lid is marginally smaller than the size of the recess in the glass ceramic panel, wherein preferably the recess is formed as a circular hole, while the lid is formed as a circular disk.

According to the preferred embodiment of the present invention, the water reservoir includes an inclined side wall, wherein the diameter of said water reservoir increases from the bottom to the top, and wherein preferably the lid is supported directly or indirectly by the inclined side wall of the water reservoir. This structure allows an easy access for the user in order to m clean the water reservoir. The inclined side wall allows the supporting of the lid by low complexity.

Advantageously, the lid comprises a lid frame attached at an outer portion of the bottom side of said lid, wherein preferably the lid frame is supported by the inclined side wall of the water reservoir and, in turn, the lid is supported by the lid frame.

For example, the lid frame is made of at least one polymeric material, wherein preferably the lid frame is glued to the outer portion of the bottom side of the lid. The lid frame also prevents leakage of steam from the edge of the lid.

Further, the lid may include at least one access opening, in particular two access openings, so that the lid is manually removable from the recess, wherein preferably at least one hole is formed beneath said access opening, so that condensed water is drainable into the water reservoir.

Moreover, the cooking hob may comprise at least one water level sensor arranged at or in the water reservoir, wherein preferably the cooking hob comprises a maximum water level sensor for detecting an allowed maximum level of the water in the water reservoir and a minimum water level sensor for detecting an allowed minimum level of the water in the water reservoir. The one or more water level sensors allow an automatic or assisted-manual steam cooking process.

In particular, for an automatic control of a steam cooking process, the cooking hob comprises a water tap connected to the water reservoir on the one hand and connectable or connected to a water supply on the other hand, wherein preferably the water tap is automatically controllable or controlled by a control unit of the cooking hob. The water tap allows the automatic steam cooking process.

Furthermore, the cooking hob may comprise at least one temperature sensor arranged at or in the water reservoir and provided for detecting the temperature of the water in the water reservoir.

For example, the at least one heating element is an induction heating element and/or a tubular heating element.

According to a further embodiment of the present invention, the lid is formed as a conical or concave disk, wherein the vertex points downwards, and wherein preferably a central recess is formed in said lid. In this case, the lid and the glass ceramic panel form the smooth and partially conical or concave surface, wherein the conical or concave part is arranged within the lid. The conical or concave lid allows collecting of pouring water, condensed water and food juices. The optional central recess is provided for refilling water in case of manual pouring.

The present invention relates further to a method for controlling a steam cooking process performed by a cooking hob with at least one steam generator, wherein said method comprises the steps of:
a) starting the steam cooking process,
b) detecting the level of water in a water reservoir of the steam generator,
c) refilling the water reservoir, if the water level is lower than the minimum level of the water,
d) detecting the temperature of the water in the water reservoir and comparing said temperature with at least one set temperature value,
e) activating a heating element of the steam generator at a high power, if the temperature of the water in the water reservoir is below the set temperature value,
f) deactivating the heating element, if the temperature of the water in the water reservoir is above the set temperature value, and
g) outputting an overheat signal, if the temperature of the water in the water reservoir is above the set temperature value,

and wherein preferably the steps b) and d) are continuously repeated and, if necessary, the steps c), e), f) and/or g), respectively, are subsequently executed.

Preferably, the detected temperature of the water in the water reservoir is compared with a lower set temperature value and an upper set temperature value, wherein the heating element is activated at high power, if the temperature of the water in the water reservoir is below the lower set temperature value, or the heating element is deactivated, if the temperature of the water in the water reservoir is above the upper set temperature value, or the heating element is activated in a simmer mode, if the temperature of the water in the water reservoir is between the lower set temperature value and the upper set temperature value.

Furthermore, the refilling of the water reservoir in step c) is performed automatically by opening and closing at least one water tap interconnected between the water reservoir and a water supply. Alternatively, the refilling of the water reservoir in step c) is performed manually by the user after a refill signal has been output. In the first case, the steam cooking process may be performed without any intervention of the user. In the latter case, the steam cooking process may be performed by a cooking hob with low complexity.

At last, the method is performed or performable by a cooking hob m with at least one steam generator mentioned above.

Novel and inventive features of the present invention are set forth in the appended claims.

The present invention will be described in further detail with reference to the drawings, in which

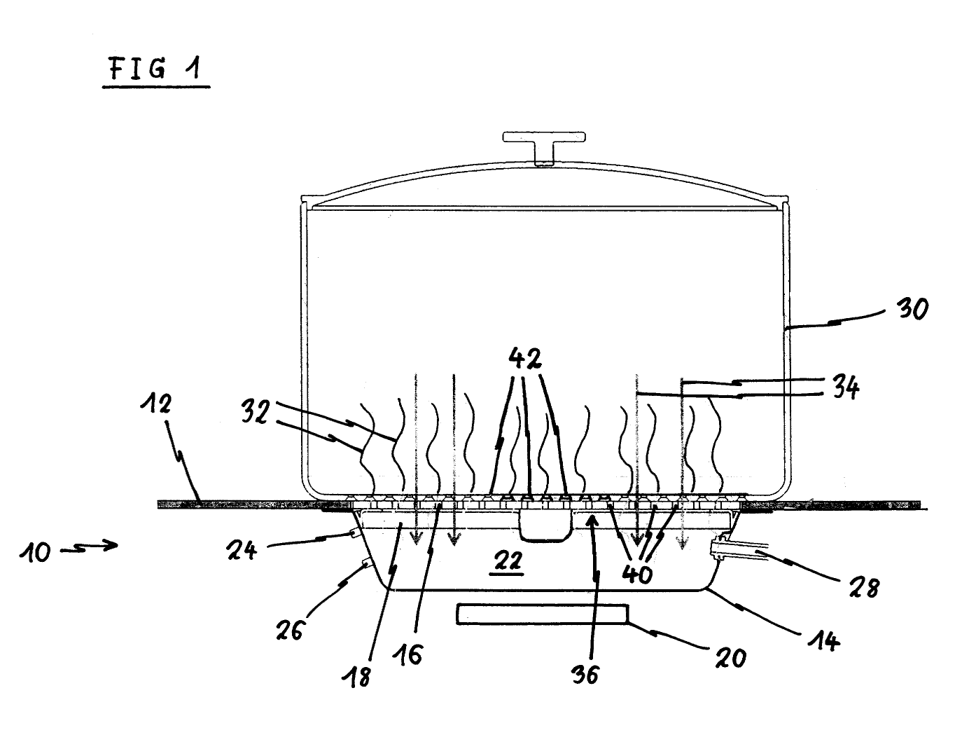

FIG. 1 illustrates a schematic sectional partial side view of a cooking hob with a steam generator according to a preferred embodiment of the present invention,

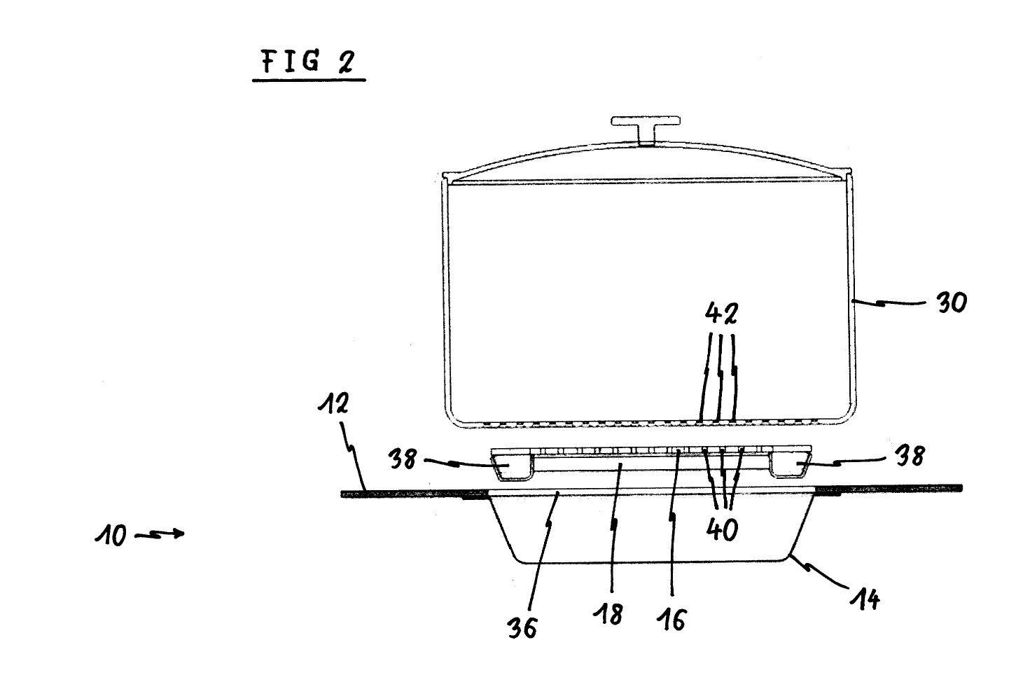

FIG. 2 illustrates a schematic exploded sectional partial side view of the cooking hob with the steam generator according to the preferred embodiment of the present invention,

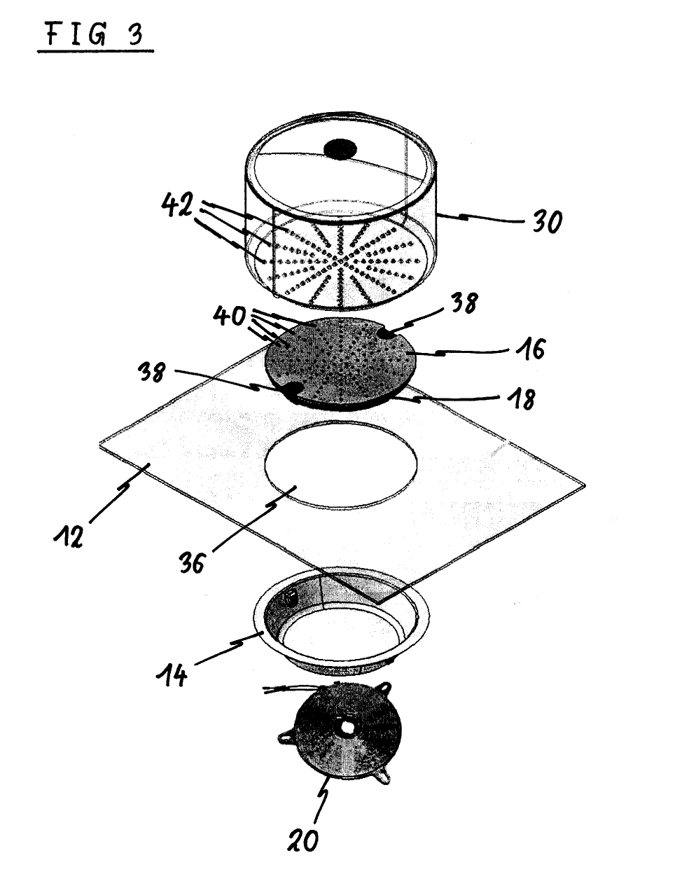

FIG. 3 illustrates a schematic exploded partial perspective view of the cooking hob with the steam generator according to the preferred embodiment of the present invention,

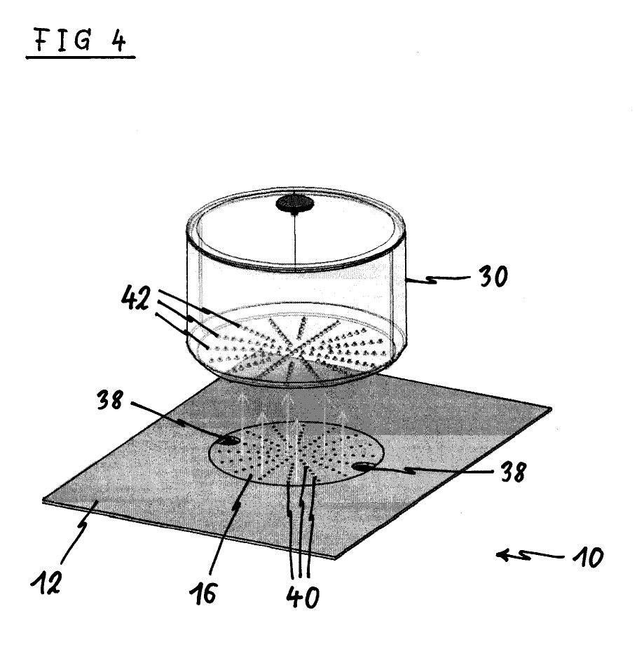

FIG. 4 illustrates a schematic partial perspective view of the cooking hob with the steam generator according to the preferred embodiment of the present invention,

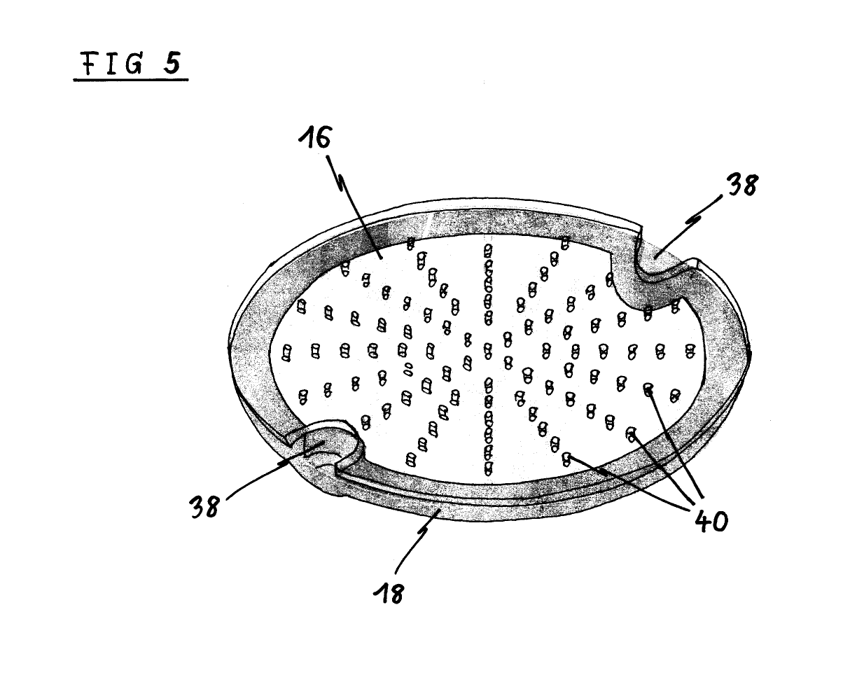

FIG. 5 illustrates a schematic perspective view of a lid for the cooking hob with the steam generator according to the preferred embodiment of the present invention,

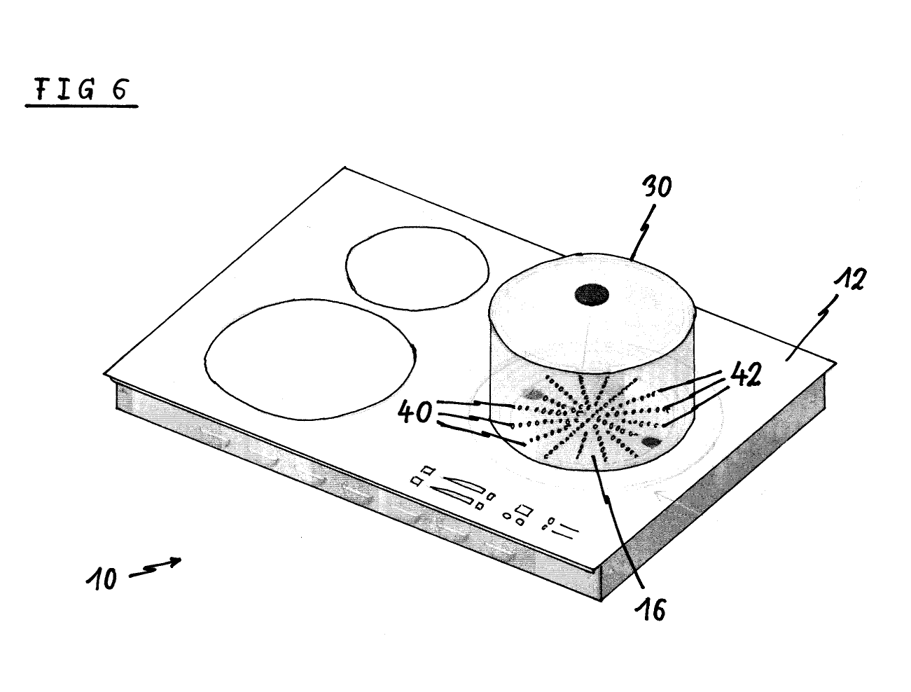

FIG. 6 illustrates a schematic perspective view of the cooking hob with the steam generator according to the preferred embodiment of the present invention,

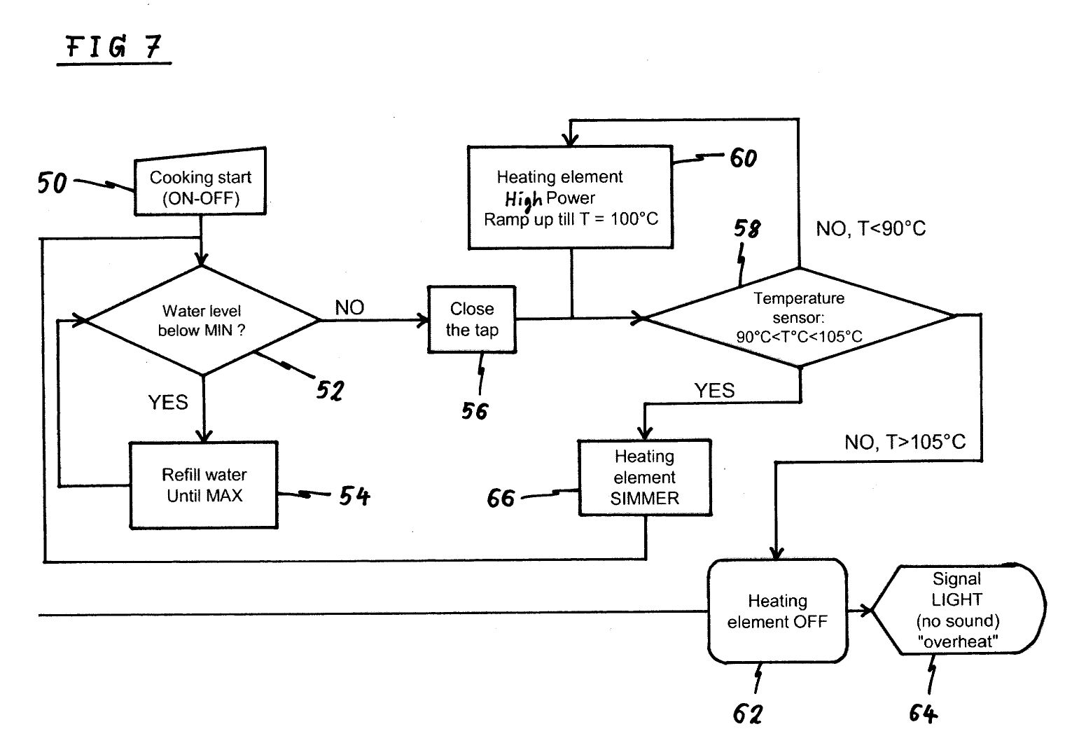

FIG. 7 illustrates a schematic flow chart diagram of a method for controlling an automatic steam cooking process by the cooking hob with the steam generator according to the preferred embodiment of the present invention,

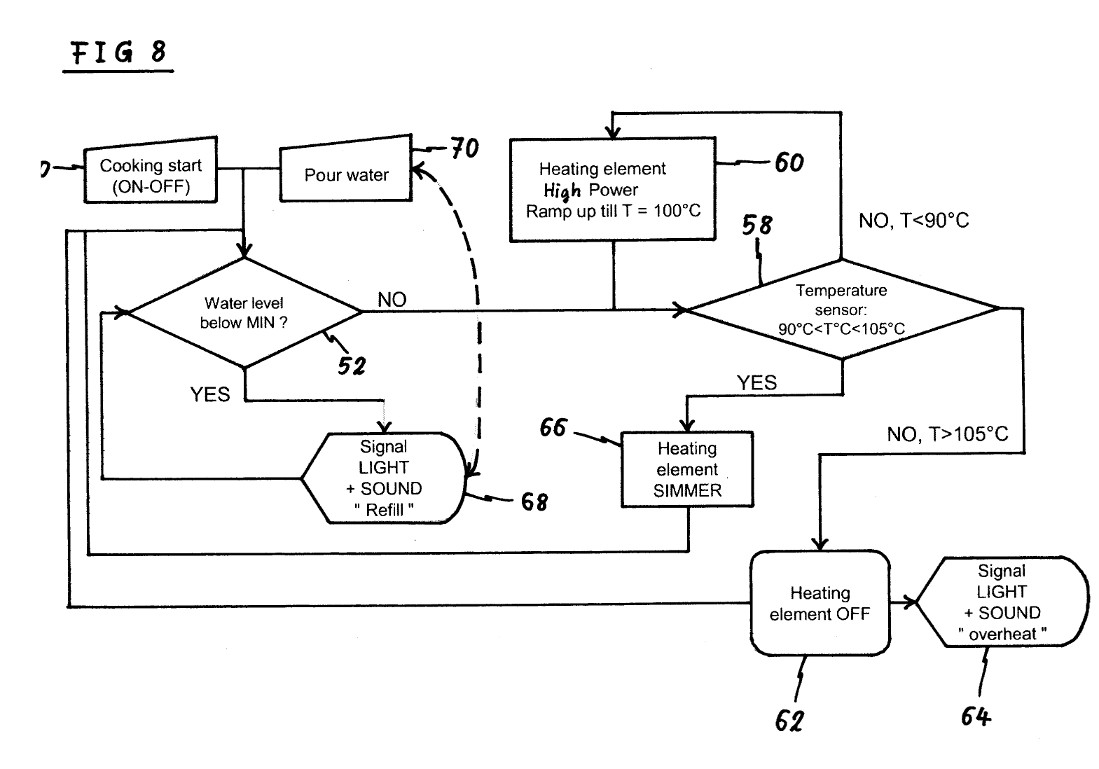

FIG. 8 illustrates a schematic flow chart diagram of a method for controlling an assisted-manual steam cooking process by the cooking hob with the steam generator according to the preferred embodiment of the present invention,

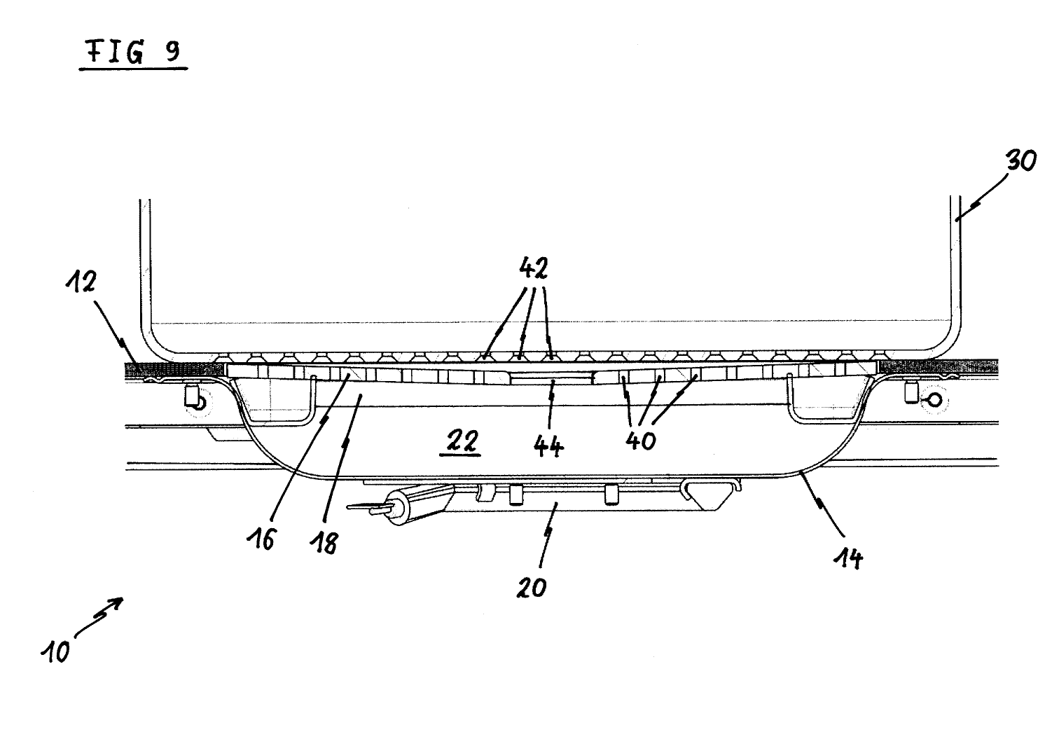

FIG. 9 illustrates a schematic sectional partial side view of the cooking hob with the steam generator according to a further embodiment of the present invention, and

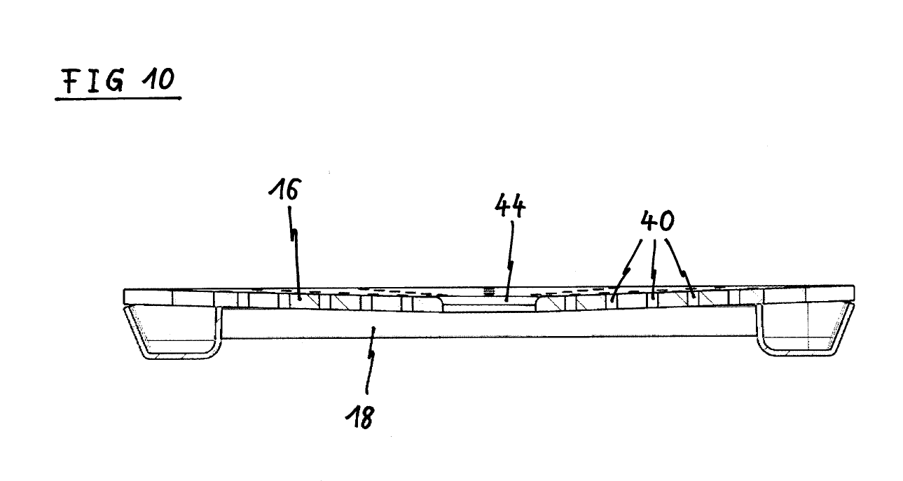

FIG. 10 illustrates a schematic sectional side view of the lid according to the further embodiment of the present invention.

FIG. 1 illustrates a schematic sectional partial side view of a cooking hob 10 with a steam generator according to a preferred embodiment of the present invention. In FIG. 1 a standard steam cooking pot 30 is placed upon said cooking hob 10.

The cooking hob 10 comprises a glass ceramic panel 12 and a water reservoir 14. The glass ceramic panel 12 includes a recess 36. In this example, the recess 36 is formed as a circular hole.

The recess 36 is closed by a removable lid 16. The upper surfaces of the glass ceramic panel 12 and the lid 16 are at the same level. Thus, the glass ceramic panel 12 and the lid 16 form a smooth surface. The water reservoir 14 is arranged beneath the lid 16 and the recess 36. The water reservoir 14 is fastened at the bottom side of the glass ceramic panel 12. In this example, a border or flange of the water reservoir 14 is glued at a bottom side of the glass ceramic panel 12, wherein said border or flange encloses an open top side of the water reservoir 14. The water reservoir 14 according to the preferred embodiment includes a flat bottom wall formed as a circular disk and an inclined side wall enclosing said bottom wall, wherein the diameter of the water reservoir 14 increases from the bottom to the top. Preferably, the water reservoir 14 is formed as a single-piece part.

Further, the cooking hob 10 comprises a heating element 20 arranged beneath the water reservoir 14. For example, the heating element 20 may be an inductive or tubular heating element. The water reservoir 14 is filled or fillable with water 22. In this example, the water reservoir 14 includes a maximum water level sensor 24 and a minimum water level sensor 26. Optionally, the water reservoir 14 includes a water tap 28. In this example, the maximum water level sensor 24, the minimum water level sensor 26 and the water tap 28 are attached at the side wall of the water reservoir 14. The maximum water level sensor 24 is provided for detecting an allowed maximum level of the water 22 inside the water reservoir 14. In a similar way, the minimum water level sensor 26 is provided for detecting an allowed minimum level of the water 22 inside the water reservoir 14. The water tap 28 is connectable or connected to a water supply. The water tap 28 is provided for refilling the water reservoir 14 with water 22. Preferably, the water reservoir 14 is automatically refilled or refillable, wherein the water tap 28 is controlled by a control unit of the cooking hob 10. Moreover, the cooking hob 10 comprises a temperature sensor, which is not shown in the drawings. For example, said temperature sensor is arranged in or at the water reservoir 14.

The lid 16 includes a plurality of lid holes 36. A bottom of the steam cooking pot 30 includes a plurality of pot holes 42. When the steam cooking pot 30 is arranged upon the lid 16, then the lid holes 36 and the pot holes 42 overlap at least partially, so that the inner spaces of the steam cooking pot 30 and the water reservoir 14 are connected to each other.

When the water reservoir 14 is filled with water 22 and the heating element 20 is activated, then the water 22 boils and steam 32 is generated within said water reservoir 14. Then, the steam 32 escapes through the lid holes 36 and infiltrates through the pot holes 42 into the steam cooking pot 30. A food stuff placed in the steam cooking pot 30 is treated by the steam 32. Condensed water 34 formed inside the steam cooking pot 30 can flow back through the pot holes 42 and the lid holes 36 into the water reservoir 14 again.

FIG. 2 illustrates a schematic exploded sectional partial side view of the cooking hob 10 with the steam generator according to the preferred embodiment of the present invention. The plurality of pot holes 42 is formed in the bottom of the steam cooking pot 30. The plurality of lid holes 36 is formed in the lid 16.

Further, the lid 16 comprises a lid frame 18 attached at the outer portion of the bottom side of said lid 16. The shape of the lid frame 18 is adapted to the inclined side wall of the water reservoir 14, so that the upper surfaces of the glass ceramic panel 12 and the lid 16 are at the same level, when the lid 16 is inserted in the recess 36. The inclined side wall of the water reservoir 14 supports the lid frame 18. In turn, the lid frame 18 supports the lid 16. For example, the lid frame 18 is made of a polymeric material. Preferably, the lid frame 18 is glued to the lid 16.

Moreover, the lid 16 includes two access openings 38 arranged at opposite outer portions of said lid 16. The access openings 38 allow the user to remove easily the lid 16 from the recess 36. Optionally, at least one hole may be formed below one or both access openings 38, so that the condensed water 34 can flow back from the steam cooking pot 30 into the water reservoir 14 again. The border or flange of the water reservoir 14 is glued at the bottom side of the glass ceramic panel 12, wherein said border or flange encloses the open top side of the water reservoir 14.

Preferably, the water reservoir 14 is made of stainless steel. The shape and the material of the water reservoir 14 allow an easy cleaning of said water reservoir 14 by the user. The removable lid 16 allows an easy access to the water reservoir 14 for the user in order to clean said water reservoir 14.

FIG. 3 illustrates a schematic exploded partial perspective view of the cooking hob 10 with the steam generator according to the preferred embodiment of the present invention.

The glass ceramic panel 12 includes the recess 36 formed as circular hole. The recess 36 is closed or closable by the removable lid 16. The lid 16 is formed as a circular disk. The diameter of the lid 16 is marginally smaller than the diameter of the recess 36. The water reservoir 14 is arranged beneath the lid 16 and the recess 36. The water reservoir 14 is fastened at the bottom side of the glass ceramic panel 12. In this example, the border or flange of the water reservoir 14 is glued at the bottom side of the glass ceramic panel 12, wherein said border or flange encloses the open top side of the water reservoir 14. The water reservoir 14 according to the preferred embodiment includes the flat bottom wall formed as circular disk and the inclined side wall enclosing said bottom wall, wherein the diameter of the water reservoir 14 increases from the bottom to the top. In this example, the water reservoir 14 is formed as a single-piece part. The heating element 20 is arranged beneath the water reservoir 14. For example, the heating element 20 may be an inductive or tubular heating element. The steam cooking pot 30 is arrangeable upon the lid 16, so that the lid holes 36 and the pot holes 42 overlap at least partially. By this way, the inner spaces of the steam cooking pot 30 and the water reservoir 14 are connected to each other.

FIG. 4 illustrates a schematic partial perspective view of the cooking hob 10 with the steam generator according to the preferred embodiment of the present invention. Preferably, the lid 16 is made of ceramic glass. Thus, the lid 16 may have the same design as the glass ceramic panel 12. The upper surfaces of the glass ceramic panel 12 and the lid 16 are at the same level, so that the glass ceramic panel 12 and the lid 16 may form a smooth surface.

FIG. 5 illustrates a schematic perspective view of the lid 16 for the cooking hob 10 with the steam generator according to the preferred embodiment of the present invention. In particular, the lid 16 is made of ceramic glass, while the lid frame 18 is made of polymeric material. Preferably, the lid frame 18 is glued to the lid 16. The access openings 38 allow the user to remove easily the lid 16 from the recess 36. The optional hole or holes formed below one or both access openings 38 allow or contribute that the condensed water 34 can flow back from the steam cooking pot 30 into the water reservoir 14 again.

FIG. 6 illustrates a schematic perspective view of the cooking hob 10 with the steam generator according to the preferred embodiment of the present invention. In this example, the cooking hob 10 comprises three cooking zones. A steam cooking zone is arranged on the right hand side, while two further cooking zones are arranged on the left hand side. In particular, said further cooking zones are induction, radiant and/or gas cooking zones.

Alternatively, the cooking hob 10 may be a single module with one cooking zone and one steam generator beneath said cooking zone. The cooking hob 10 with the steam cooking zone and optional further cooking zones may be integrated within a cooktop or formed as a free standing cooking hob. The steam cooking zone can be integrated also with free standing steam cookers.

FIG. 7 illustrates a schematic flow chart diagram of a method for controlling an automatic steam cooking process by the cooking hob 10 with the steam generator according to the preferred embodiment of the present invention. In particular, the method is provided for the cooking hob 10 with the steam generator mentioned above.

In a first step 50 the steam cooking process is started by operating a switch, e.g. an on-off switch. In a second step 52 the water level in the water reservoir 14 is detected by the minimum water level sensor 26. If the water level is below the allowed minimum level, then in a step 54 the water 22 is automatically refilled into the water reservoir 14, until it reaches the maximum water level sensor 24. Then, again in step 52 the water level in the water reservoir 14 is detected by the minimum water level sensor 26 a further time. If the water level is above the allowed minimum level, then in a step 56 the water tap 28 is closed.

In a next step 58 the temperature T of the water 22 in the water reservoir 14 is detected and compared with a lower set temperature value and an upper set temperature value. Ideally, for the steam cooking process the temperature T of the water 22 should be between the lower set temperature value and the upper set temperature value. In this example, the lower set temperature value is 90° C., while the upper set temperature value is 105° C. Preferably, the lower set temperature value is between 85° C. and 95° C., while the upper set temperature value is between 100° C. and 110° C.

If the temperature T of the water 22 in the water reservoir 14 is below the lower set temperature value, then in a step 60 the heating element is activated at high power. If the temperature T of the water 22 in the water reservoir 14 is above the upper set temperature value, then in a step 62 the heating element is deactivated and in a subsequent step 64 an overheat signal is output. In this example, the overheat signal is an optical signal indicated by a light source. If the temperature T of the water 22 in the water reservoir 14 is between the lower set temperature value and the upper set temperature value, then in a step 66 the heating element is activated in a simmer mode.

During the steam cooking process the step 52 of detecting the level of the water 22 in the water reservoir 14 and the step 58 of detecting and comparing the temperature T of the water 22 in the water reservoir 14 are continuously repeated, so that the water reservoir 14 can be automatically refilled, if necessary. The method shown in FIG. 7 allows an automatic control of the steam cooking process by the cooking hob 10 with the steam generator.

FIG. 8 illustrates a schematic flow chart diagram of a method for controlling an assisted-manual steam cooking process by the cooking hob 10 with the steam generator according to the preferred embodiment of the present invention.

In the first step 50 the steam cooking process is started by operating the designated switch, e.g. the on-off switch. In the next step 52 the water level in the water reservoir 14 is detected by the minimum water level sensor 26. If the water level is below the allowed minimum level, then a refill signal is output in a step 68. In this example, the refill signal is an optical and acoustic signal. In a subsequent step 70 the water reservoir 14 is manually refilled or refillable with water 22 by the user. Then, again in step 52 the level of the water 22 in the water reservoir 14 is detected by the minimum water level sensor 26 a further time. If the level of the water 22 is still below the allowed minimum level, then in step 68 the refill signal is output again or still, and the user has to refill manually the water reservoir 14 with water 22 in step 70. If the level of the water 22 is above the allowed minimum level, then the step 58 of detecting and comparing the temperature T of the water 22 in the water reservoir 15 is activated.

In the step 58 it is compared, if the detected temperature T of the water 22 in the water reservoir 14 is between the lower set temperature value and the upper set temperature value. Also in this example, the lower set temperature value is 90° C., while the upper set temperature value is 105° C. Preferably, the lower set temperature value is between 85° C. and 95° C., while the upper set temperature value is between 100° C. and 110° C.

If the temperature T of the water 22 in the water reservoir 14 is below the lower set temperature value, then in step 60 the heating element is activated at high power. If the temperature T of the water 22 in the water reservoir 14 is above the upper set temperature value, then in step 62 the heating element is deactivated and in the subsequent step 64 the overheat signal is output. In this example, the overheat signal is an optical signal and an acoustic signal. If the temperature T of the water 22 in the water reservoir 14 is between the lower set temperature value and the upper set temperature value, then in the step 66 the heating element is activated in the simmer mode.

During the steam cooking process the step 52 of detecting the water level in the water reservoir 14 and the step 58 of detecting and comparing the temperature T of the water 22 in the water reservoir 14 are continuously repeated. The method shown in FIG. 8 allows an assisted-manual control of the steam cooking process by the cooking hob 10 with the steam generator. Only the refilling of water 22 into the water reservoir 14 has to be manually performed by the user. The assisted-manual control of the steam cooking process does not require the water tap 28 and its connection to the water supply. Thus, the assisted-manual control of the steam cooking process can be performed by the cooking hob 10 with the steam generator with low complexity.

In the case of the assisted-manual control of the steam cooking process the minimum water level sensor 26 at the water reservoir 14 may be optional, while the empty water reservoir 14 is detected by the temperature sensor, so that an “overheat” signal becomes a “refill” signal.

FIG. 9 illustrates a schematic sectional partial side view of the cooking hob 10 with the steam generator according to a further embodiment of the present invention. In FIG. 9 the standard steam cooking pot 30 is placed upon said cooking hob 10.

The cooking hob 10 comprises the glass ceramic panel 12 and the water reservoir 14. The glass ceramic panel 12 includes the recess 36 formed as the circular hole. The recess 36 is closed by the removable lid 16. The water reservoir 14 is arranged beneath the lid 16 and the recess 36. The water reservoir 14 according to the further embodiment also includes the flat bottom wall formed as the circular disk and the inclined side wall enclosing said bottom wall, wherein the diameter of the water reservoir 14 increases from the bottom to the top. Preferably, the water reservoir 14 is formed as a single-piece part. Further, the cooking hob 10 comprises a heating element 20 arranged beneath the water reservoir 14. For example, the heating element 20 may be an inductive or tubular heating element. The water reservoir 14 is filled or fillable with water 22.

The cooking hob 10 according to the further embodiment differs from the cooking hob 10 of the preferred embodiment mentioned above in that the lid 16 is formed as a conical disk, wherein the vertex points downwards. The conical lid 16 allows collecting of pouring water, condensed water and food juices. In this case, the lid 16 and the glass ceramic panel 12 form a smooth and partially conical surface, wherein the conical part is arranged within the lid 16.

Additionally, a central recess 44 is formed in the lid 14. The central recess 44 is provided for refilling water in case of manual pouring. The upper surfaces of the glass ceramic panel 12 and the border of the lid 16 are at the same level.

The lid 16 includes the plurality of lid holes 36. A bottom of the steam cooking pot 30 includes the plurality of pot holes 42. When the steam cooking pot 30 is arranged upon the lid 16, then a hollow is formed between said lid 16 and the bottom of said steam cooking pot 30. Thus, the lid holes 36 and the pot holes 42 form certainly passages from the water reservoir 14 to the inner space of the steam cooking pot 30.

FIG. 10 illustrates a schematic sectional side view of the lid 16 according to the further embodiment of the present invention. The lid 16 is formed as conical disk, wherein the vertex points downwards. The central recess 44 is formed around the vertex of the lid 14. The lid 16 includes the plurality of lid holes 36.

Further, the lid 16 comprises the lid frame 18 attached at the outer portion of the bottom side of said lid 16. The shape of the lid frame 18 is adapted to the inclined side wall of the water reservoir 14, so that the upper surfaces of the glass ceramic panel 12 and the border of the lid 16 are at the same level, when the lid 16 is inserted in the recess 36. The inclined side wall of the water reservoir 14 supports the lid frame 18. In turn, the lid frame 18 supports the lid 16. For example, the lid frame 18 is made of polymeric material and is glued to the lid 16.

Additionally, the lid 16 includes the two access openings 38 arranged at the opposite outer portions of said lid 16. The access openings 38 allow the user to remove easily the lid 16 from the recess 36. Optionally, at least one hole may be formed below one or both access openings 38, so that the condensed water 34 can flow back from the steam cooking pot 30 into the water reservoir 14 again.

The cooking hob with the integrated steam generator according to the present invention allows the use of the standard steam cooking pot 30 or a bamboo steamer. The arrangement of the lid 16 in the recess 36 of the glass ceramic panel results in the smooth surface on the cooking hob 10. Said smooth surface allows the compatibility with every kind of steam cooking pots and bamboo steamers. The steam 32 is directly injected into the steam cooking pot 30 or bamboo steamer, respectively. The steam 32 may be injected in less than one minute, in particular, if the heating element is an induction or tubular heating element. For example, the cooking hob with the steam generator may be integrated in a multi surface cooktop.

Although an illustrative embodiment of the present invention has been described herein with reference to the accompanying drawing, it is to be understood that the present invention is not limited to that precise embodiment, and that various other changes and modifications may be affected therein by one skilled in the art without departing from the scope or spirit of the invention. All such changes and modifications are intended to be included within the scope of the invention as defined by the appended claims.

### LIST OF REFERENCE NUMERALS

10 cooking hob
12 glass ceramic panel
14 water reservoir
16 lid
18 lid frame
20 heating element
22 water
24 maximum water level sensor
26 minimum water level sensor
28 water tap
30 steam cooking pot
32 steam
34 condensed water
36 recess
38 access opening
40 lid hole
42 pot hole
44 central recess
50 step of starting the steam cooking process
52 step of detecting the water level
54 step of refilling the water reservoir 14
56 step of closing the water tap 28
58 step of detecting and comparing the temperature T
60 step of activating the heating element at high power
62 step of deactivating the heating element 20
64 step of outputting an overheat signal
66 step of activating the heating element in simmer mode
68 step of outputting a refill signal
70 step of manual refilling water

T temperature of the water 22

1. A cooking hob with at least one steam generator, comprising:
a glass ceramic panel including at least one recess,
at least one water reservoir arranged beneath the recess,
at least one removable lid for closing the recess, the lid including a plurality of lid holes permeable for steam, and
at least one heating element arranged beneath, besides and/or inside the at least one water reservoir,
the at least one lid being arranged or arrangeable in the at least one recess of the glass ceramic panel, so that respective upper surfaces of the at least one lid and the glass ceramic panel are at the same level and form either a smooth or a smooth and partially concave surface, and
the at least one lid and/or a portion of the glass ceramic panel encircling said at least one lid are provided for supporting a standard steam cooking pot or a bamboo steamer, so that during operation steam is directed from the at least one water reservoir through the lid holes into the steam cooking pot or the bamboo steamer, respectively.

2. The cooking hob according to claim 1, wherein the at least one lid is made of ceramic glass.

3. The cooking hob according to claim 1, wherein the lid having a size marginally smaller than the at least one recess in the glass ceramic panel.

4. The cooking hob according to claim 1, wherein the at least one water reservoir includes an inclined side wall and has a diameter that, increases from a bottom to a top thereof.

5. The cooking hob according to claim 1, wherein the at least one lid comprises a lid frame attached at an outer portion of a bottom side of said at least one lid.

6. The cooking hob according to claim 5, wherein the lid frame is made of at least one polymeric material, and is glued to the outer portion of the bottom side of the at least one lid.

7. The cooking hob according to claim 1, wherein the at least one lid includes at least one access opening so that the at least one lid is manually removable from the at least one recess.

8. The cooking hob according to claim 1, further comprising at least one water level sensor arranged at or in the water reservoir, a maximum water level sensor for detecting an allowed maximum level of water in the at least one water reservoir, and a minimum water level sensor for detecting an allowed minimum level of water in the at least one water reservoir.

9. The cooking hob according to claim 1, further comprising a water tap connected to the at least one water reservoir on the one hand and connectable or connected to a water supply on the other hand, the water tap being automatically controllable or controlled by a control unit of the cooking hob.

10. The cooking hob according to claim 1, further comprising at least one temperature sensor arranged at or in the at least one water reservoir and provided for detecting a temperature (T) of water in the at least one water reservoir.

11. The cooking hob according to claim 1, wherein the at least one lid is formed as a conical or concave disk having a vertex that points downwards.

12. A method for controlling a steam cooking process performed by a cooking hob with at least one steam generator, comprising:
a) starting the steam cooking process,
b) detecting a level of water in a water reservoir of the at least one steam generator,
c) refilling the water reservoir if the water level is lower than a minimum water level,
d) detecting a temperature (T) of the water in the water reservoir and comparing said temperature (T) with at least one set temperature value,
e) activating a heating element of the steam generator at a high power if the temperature (T) of the water in the water reservoir is below the set temperature value,
f) deactivating the heating element if the temperature (T) of the water in the water reservoir is above the set temperature value, and
g) outputting an overheat signal if the temperature (T) of the water in the water reservoir is above the set temperature value,
and wherein said steps b) and d) are continuously repeated and said steps c), e), f) and/or g), respectively, are subsequently executed as required based thereon.

13. The method according to claim 12, wherein the detected temperature (T) of the water in the water reservoir is compared with a lower set temperature value and an upper set temperature value, wherein the heating element is activated at high power if the temperature (T) of the water in the water reservoir is below the lower set temperature value, the heating element is deactivated if the temperature (T) of the water in the water reservoir is above the upper set temperature value, and the heating element is activated in a simmer mode if the temperature (T) of the water in the water reservoir is between the lower set temperature value and the upper set temperature value.

14. The method according to claim 12, wherein the refilling of the water reservoir in step c) is performed automatically by opening and closing at least one water tap interconnected between the water reservoir and a water supply, or the refilling of the water reservoir in step c) can be performed manually by the user after a refill signal has been output.

15. (canceled)

16. The cooking hob according to claim 2, the at least one lid being made of the same material as the glass ceramic panel.

17. The cooking hob according to claim 4, the at least one lid being supported directly or indirectly by the inclined side wall of the at least one water reservoir.

18. The cooking hob according to claim 7, said at least one hole being formed beneath said at least one access opening so that condensed water is drainable into the at least one water reservoir.

19. The cooking hob according to claim 11, wherein a central recess is formed in said at least one lid.

20. A cooking hob comprising a glass ceramic panel having a first cooking zone and a second cooking zone, said first cooking zone being a steam cooking zone and said second cooking zone being selected from among induction, radiant and gas cooking zones, said steam cooking zone comprising a hole in said glass ceramic panel, a water reservoir beneath said recess, a lid dimensioned to fit in said opening to cover said water reservoir, said lid having a plurality of lid holes therein effective to transmit steam generated in said water reservoir, said plurality of lid holes being adapted to be aligned with a corresponding plurality of pot holes in a steam cooking pot when such a pot is arranged on an upper surface of said lid during use, said water reservoir having an inclined side wall, said lid comprising a lid frame having a shape adapted to the inclined side wall of the water reservoir so that respective upper surfaces of the glass ceramic panel and at least an outer portion of the lid are at the same level when the lid is inserted in the hole and said lid frame is supported by said side wall, said lid further comprising first and second access openings arranged at opposite outer portions of said lid to enable manual removal of said lid from said opening in said hob in order to provide access to said water reservoir through said hole for cleaning thereof, a temperature sensor associated with said water reservoir for detecting a temperature (T) of water therein, and a heating element for delivering heat to said water reservoir to generate steam from water therein, said cooking hob being adapted to: a) activate said heating element at a high level while said temperature is below a lower set temperature value, b) deactivate said heating element while said temperature is above an upper set temperature value, and c) activate said heating element in a simmer mode when said temperature is between said upper and lower set temperature values.

21. The cooking hob according to claim 20, said lid hole being a circular hole and said lid being a conical disc whose vertex points downward toward said water reservoir, a central recess formed in said lid effective to permit manual pouring of water into said water reservoir through said lid, said water reservoir further comprising a minimum water level sensor for detecting a minimum allowable water level in said water reservoir, and a maximum water level sensor for detecting a maximum allowable water level in said water reservoir.
